(19) United States
(12) Patent Application Publication
(10) Pub. No.: US 2004/0009350 A1
(43) Pub. Date: Jan. 15, 2004

(54) Methods of heat treating barium titanate-based particles and compositions formed from the same

(76) Inventors: Stephen J. Krause, Phoenixville, PA (US); Sridhar Venigalla, Macungie, PA (US); Stephen A. Constantino, Reading, PA (US)

Correspondence Address: Martha Ann Finnegan, Esq., Cabot Corporation, 157 Concord Road, Billerica, MA, 01821, US

(21) Appl. No.: 10/194,935

(22) Filed: Jul. 12, 2002

(51) Int. Cl. B32B 5/16

(52) U.S. Cl. 428/386; 428/403

(57) ABSTRACT

Methods of heat treating barium titanate-based particles are provided, as well as compositions and devices formed from the particles. The methods involve forming a coating on surfaces of barium titanate-based particles and heating the coated particles, for example, to a temperature of greater than about 400° C. and less than about 1150° C. The heating step may increase the bond strength between the coating and barium titanate-based particles, reduce the average specific surface area of the coated particles, remove water present in the coating, and remove other contaminants from the composition, amongst other advantages. These effects of heat treating can improve the performance of devices (e.g., MLCCs) that include dielectric layers formed from the barium titanate-based particles.

### FIELD OF INVENTION

The invention relates generally to dielectric materials and, more particularly, to methods of heat treating barium titanate-based particles and compositions formed from the particles.

### BACKGROUND OF INVENTION

Barium titanate-based materials, which include barium titanate (BaTiO₃) and its solid solutions, may be used to form dielectric layers in electronic devices such as multilayer ceramic capacitors (MLCCs). Typically, barium titanate-based particles are processed by dispersing the particles in a liquid to which other components (e.g., dispersants and binder) are added to form a slip. The slip may be cast to form a green layer upon which an electrode is formed. Additional green layers and electrodes may be formed on one another to produce a structure that includes alternating green layers and electrodes. The structure is sintered to form a MLCC that includes densified dielectric layers.

Dopants can be added to barium titanate-based materials during processing to improve properties, in particular electrical properties, of the composition. Typically, the dopants are metallic compounds such as metal oxides, hydroxides, or hydrous oxides. In some cases, the dopant compounds are added to a barium titanate-based particulate composition in the form of discrete particles. The dopant particles may be physically mixed with the barium titanate-based particles to form a doped composition.

In other cases, dopant compounds may be coated on surfaces of the barium titanate-based particles. Coating dopant compounds on particle surfaces may increase the uniformity of dopant distribution throughout the composition which can lead to a more uniform microstructure in the resulting dielectric layer and, thus, improved device performance. However, if coatings become detached from particle surfaces during subsequent processing steps (e.g., milling or mixing steps), the uniformity of dopant distribution may be sacrificed.

### SUMMARY OF INVENTION

The invention provides methods of heat treating barium titanate-based particles, as well as compositions and devices formed from the particles.

In one aspect, the invention provides a method of processing barium titanate-based particles. The method comprises hydrothermally producing barium titanate-based particles, and forming a coating on surfaces of the barium titanate-based particles to produce coated barium titanate-based particles. The method further comprises heating the coated barium titanate-based particles to a temperature of greater than about 400° C. and less than about 1150° C. to produce heat-treated, coated barium titanate-based particles.

In another aspect, the invention provides a method of processing barium titanate-based particles. The method comprises hydrothermally producing barium titanate-based particles and forming a coating on surfaces of the barium titanate-based particles to produce coated barium titanate-based particles. The method further comprises heating the coated barium titanate-based particles to a temperature of greater than about 400° C. to produce heat-treated, coated barium titanate-based particles. The method further comprises forming a green layer comprising the heat-treated, coated barium titanate-based particles, and sintering the green layer.

In another aspect, the invention provides a method of processing barium titanate-based particles. The method comprises forming a coating on surfaces of barium titanate-based particles to produce coated barium titanate-based particles having an average specific surface area. The method further comprises reducing the average specific surface area of the coated barium titanate-based particles by heating the coated barium titanate-based particles.

In another aspect, the invention provides a method of processing barium titanate-based particles that comprises forming a dopant coating on surfaces of barium titanate-based particles to produce coated barium titanate-based particles and promoting at least partial diffusion of the dopant into the barium titanate-based particles.

In another aspect, the invention provides for a coated barium titanate particle. The coated barium titanate particle comprises a primary particle comprising barium titanate and having an average primary particle size of less than about 0.5 micron and a dopant coating disposed on the primary particle wherein the coated barium titanate particle exhibits a BET surface area of less than about 5.6 m²/g.

In another aspect, the invention provides for coated barium titanate particles. The particles comprise primary particles comprising barium titanate and have a dopant coating disposed on the primary particles wherein the dopant is at least partially diffused into the primary particles.

Other aspects, embodiments, and features of the invention will become apparent from the following detailed description. All references incorporated herein are incorporated in their entirety. In cases of conflict between an incorporated reference and the present specification, the present specification shall control.

### BRIEF DESCRIPTION OF THE DRAWINGS

FIGS. 1a and 1b are photocopies of SEM micrographs of barium titanate particles that are non-heat treated and heat treated, respectively.

FIGS. 2a (heat treated at 800° C.) and 2b (heat treated at 1000° C.) are photocopies of micrographs of the doped barium titanate particles of Example 4.

FIG. 3 is a graph illustrating the relationship between viscosity and shear rate for the four doped barium titanate samples and one undoped barium titanate sample of Example 5.

FIGS. 4a (non-heat treated) and 4b (heat treated) are photocopies of SEM micrographs (10,000×) of the top surface of the barium titanate green sheets of Example 7.

FIGS. 5a (non-heat treated) and 5b (heat treated) are photocopies of SEM micrographs (10,000×) of the bottom surface of the green sheets shown in FIGS. 4a and 4b.

### DETAILED DESCRIPTION

Methods of heat treating barium titanate-based particles are provided, as well as compositions and devices formed from the particles. The methods involve forming a coating on surfaces of barium titanate-based particles and heating the coated particles, for example, to a temperature of greater than about 400° C. and less than about 1150° C. As described further below, the heating step may increase the bond strength between the coating and barium titanate-based particles, reduce the average specific surface area of the coated particles, remove water present in the coating, and remove other contaminants from the composition, amongst other advantages. These heat treating effects can improve the performance of devices (e.g., MLCCs) that include dielectric layers formed from the barium titanate-based particles.

As used herein, “barium titanate-based” compositions refer to barium titanate, solid solutions thereof, or other oxides based on barium and titanium having the general structure ABO₃, where A represents one or more divalent metals such as barium, calcium, lead, strontium, magnesium and zinc and B represents one or more tetravalent metals such as titanium, tin, zirconium and hafnium. One type of barium titanate-based composition has the structure Ba(1-x)AₓTi(1-y)B_{y}O₃, where x and y can be in the range of 0 to 1, where A represents one or more divalent metal other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate and the like. In still other cases, where x or y is 1.0, barium or titanium may be completely replaced by the alternative metal of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)}PbₓCa_{x′}Sr_{x″O.Ti}_{(i-y-y′-y″)}Sn_{y}Zr_{y′}Hf_{y″}O₂, where x, x′, x″, y, y′, and y″ are each greater than or equal to 0. In many cases, the barium titanate-based material will have a perovskite crystal structure, though in other cases it may not. In some cases, barium titanate (i.e., BaTiO₃) particles may be preferred.

The barium titanate-based particles may have a variety of different particle characteristics. The barium titanate-based particles typically have an average primary particle size of less than about 5.0 microns; in some cases, the average primary particle size is less than about 1.0 micron; in some cases, the average primary particle size may be less than about 0.5 micron; in some cases, the average primary particle size is less than about 0.25 micron; and, in some cases, the average primary particle size is less than about 0.1 micron. The average particle size of a composition may be determined using SEM image analysis or other known techniques for determining particle size.

The barium titanate-based particles may have a variety of shapes which may depend, in part, upon the process used to produce the particles. The barium titanate-based particles may be equiaxed and/or substantially spherical, in particular, if the particles are hydrothermally produced as described further below. In some cases, the particles may have an irregular, non-equiaxed shape.

The barium titanate-based particles may be produced according to any technique known in the art including hydrothermal processes, solid-state reaction processes, sol-gel processes, as well as precipitation and subsequent calcination processes, such as oxalate-based processes. In some embodiments, it may be preferable to produce the barium titanate-based particles using a hydrothermal process. Hydrothermal processes generally involve mixing a barium source with a titanium source in an aqueous environment to form a hydrothermal reaction mixture which is maintained at an elevated temperature. When forming barium titanate particles, barium reacts with titanium and the resulting particles remain dispersed in the aqueous environment to form a slurry. The particles may be washed to remove excess barium ions from the hydrothermal process while being maintained in the slurry. When forming barium titanate solid solution particles hydrothermally, sources including the appropriate divalent or tetravalent metal are also added to the hydrothermal reaction mixture. Certain hydrothermal processes may be used to produce substantially spherical barium titanate-based particles having an average primary particle size of less than about 0.5 micron and a uniform particle size distribution. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

In some embodiments, the barium titanate-based particles may be subjected to a first heat treatment step prior to coating. This first heat treatment step is optional and is not intended to replace the heat treating step after the particles are coated. This first heat treatment step involves heating the particles, for example, to a temperature between about 400° C. and about 1150° C. The heating step can increase the average particle size and may cause the crystal structure of the particle to become tetragonal. The increased average particle size, in some cases, improves the electrical properties (i.e., dielectric constant and dissipation factor) of the particulate composition as compared to compositions that are not heat treated. In particular, it may be desirable to heat treat barium titanate-based particles prior to coating if the particles are produced in a hydrothermal process. When hydrothermally-produced barium titanate-based particles are subjected to a heat treatment step, the water in the slurry may be removed (e.g., by filtering or decanting) and the particles may be dried at a lower temperature prior to heat treatment. A suitable heat treatment process is described in commonly-owned, co-pending U.S. patent application Ser. No. 09/689,093, which was filed on Sep. 12, 2000, and is incorporated herein by reference in its entirety.

As described above, the methods of the present invention involve forming a coating on the barium titanate-based particles. The coating comprises at least one, but oftentimes more than one, dopant metal. The dopant metal(s) are selected to impart the resulting composition with the desired properties (e.g., electrical properties such as dielectric constant and dissipation factor). Any dopant metal known in the art may be used including Mg, Mn, W, Mo, V, Cr, Si, Y, Ho, Dy, Ce, Nb, Bi, Co, Ta, Zn, Al, Ca, Nd, and Sm. For some MLCC applications, Y, Mg and Mn may be preferred dopant metals. The dopant metals in the coating are typically in the form of metal oxides, hydroxides, or hydrous oxides. The form of the dopant metal compounds depends, in part, on the particular dopant metal and the coating process.

The dopant metal coatings may be formed using any suitable coating process. For example, the dopant metal coating may be formed by precipitating the dopant metal compound(s) from an aqueous solution. One suitable precipitation technique involves forming a mixture of barium titanate-based particles and appropriate dopant metal solutions. A base is added to the mixture to cause the dopant metal solutions to precipitate on surfaces of the barium titanate-based particles. In some cases, the base may be added to the mixture in a manner that causes the dopant metals to sequentially precipitate onto surfaces of the particles. The resulting particles are coated with respective layers having different dopant metal compositions, as described further below. This coating process and other suitable coating processes are described in U.S. Patent Application Serial No. not yet assigned, filed on even date herewith and entitled “Process for Coating Ceramic Particles and Compositions Formed From the Same,” by Venigalla et al, which is incorporated herein by reference in its entirety. Other suitable dopant coating processes have been described, for example, in commonly-owned U.S. Pat. No. 6,268,054, which is incorporated herein by reference in its entirety.

As described above, in some cases, the coating includes a series of chemically distinct layers. Each layer may comprise a different dopant metal compound. It should be understood that the respective layers of the coating may not be entirely chemically distinct. That is, there may be a small percentage of other dopant metal compounds within each layer and, in particular, near interfaces between adjacent layers. There may also be one or more layers that do not completely cover the particle. These small amounts of inhomogeneity within the layers do not significantly effect the overall uniformity of the composition.

In some cases, the coatings are homogeneous with each dopant metal distributed relatively uniformly throughout the coating. However, it should be understood that the homogeneous coatings may not include a perfectly homogeneous distribution of dopants.

The coating may have a porous structure, particularly if the coating is formed using the precipitation techniques described above. The porosity results in the coating having a low-density, high surface area, and sponge-like structure. The porous structure may physically trap water within the coating. It should also be understood that water may also be chemically associated with dopant coating, for example, when the dopant layer comprises a metal hydroxide or metal hydrous oxide.

The coating thickness depends, in part, upon the amount of porosity and on other factors such as particle size and the weight percentage of dopant metals. The average thickness of the dopant coating may be, for example, between about 1.0 nm and about 20.0 nm. The term “average thickness” refers to the average coating thickness for the particulate composition. It may be determined be measuring the coating thickness of a number of representative particles using known techniques such as Transmission Electron Microscopy (TEM).

The coatings may cover the entire particle surface, or only over a portion of the particle surface. In some embodiments, the coating may have a uniform thickness such that the thickness of the coating varies by less than 20% across the surface of an individual particle. In other cases, the thickness may vary by larger amounts. It is possible that some barium titanate-based particles may not be coated at all.

The weight percentage of the dopant present may be selected to provide the composition with the desired electrical properties. Generally, the barium titanate-based composition includes less than about 5 weight percent of each individual dopant element based upon the total weight of the barium titanate-based particulate composition. For example, in some cases, each individual dopant element weight percentage is between about 0.0020 and about 1.0 based upon the total weight of the barium titanate-based particulate composition; and, in some cases, each individual dopant element weight percentage is between about 0.0025 and about 0.1 based upon the total weight of the barium titanate-based particulate composition. In some cases, the total weight percentage of all dopants in the composition is between about 0.05 weight percent and about 10 weight percent based on the total weight of composition; and in some cases, between about 0.1 weight percent and about 5 weight percent.

In some embodiments, the A/B ratio of the barium titanate-based composition may be adjusted prior to the step of heat treating the coated particles. As used herein, A/B ratio is defined as the ratio of divalent metals (e.g., Ba.) to tetravalent metals (e.g., Ti) in composition of the barium titanate-based particles. The A/B ratio may be adjusted to a value greater than 1.000 (e.g., between about 1.005 and about 1.035), for example, to increase the compatibility of the composition with base metal electrodes.

The A/B ratio may be adjusted using any suitable technique. In some embodiments, a compound comprising an A group element (e.g., BaSiO₃) is coated on the barium titanate-based particles using one of the coating techniques described above. In multi-layer coatings, the A group element compound may be the final coating layer depositing on the particles. However, it should be understood that not all methods of the invention include an A/B ratio adjustment step.

As described above, the methods of the present invention involve subjecting the coated barium titanate-based particles to a heating step. The coated particles are heated to a temperature and for a time sufficient to achieve the desired effect(s). As described further below, the effects may include increasing the adhesion between the coating and particle surfaces, removing water (if present) and other volatile matter from the coating, crystallizing the coating layer, decreasing the thickness of the coating surface, and decreasing the average specific surface area of the coated particles.

The coated particles may be heated, for example, to temperatures of greater than about 400° C. and less than about 1150° C. In some cases, the coated particles are heated to a temperature of greater than about 500° C., or greater than about 800° C. In some cases, the coated particles are heated to a temperature of less than about 1000° C. The specific temperature for the heat treatment step depends upon the particular process. For example, higher temperatures (e.g., between about 800° C. and 1000° C.) may be particularly suitable for increasing the bond strength between the coating and the layer as described further below. It should be understood that the coated particles are not heated to temperatures high enough to sinter the particulate composition (e.g., between about 1200° C. and 1300° C.).

The heating time depends, in part, on the heating temperature and, for example, may be on the order of hours. However, the heat treatment step may be carried out for any length of time sufficient to achieve the desired effect(s).

In some cases, particularly when conducted at higher temperatures, the heat treatment step may cause some particle agglomeration. If desired, particle agglomeration may be reduced by milling the heat-treated, coated particles. Standard milling techniques are suitable for reducing agglomeration including hammer milling, ball milling, pin milling, long gap milling, and jet milling. In some processes of the invention, it is not necessary to mill the heat-treated, coated particles.

The heat treated, coated particles may then be further processed as desired. In some cases, the particles may be mixed with a liquid (aqueous or non-aqueous) to form a slurry. Dispersants and/or binders may be added to the slurry to form a castable slip. The slip may be cast to form a green layer. To form an MLCC, additional electrode layers and green layers may be deposited on top of one another. The resulting structure may be sintered to form a MLCC that includes alternating dielectric and electrode layers. The sintering step may, for example, involve heating the composition to a temperature of between about 1200° C. and about 1300° C. If sintering aids are added to the heat-treated composition, the sintering step may utilize lower temperatures. The dielectric layers formed from the heat-treated, coated barium titanate-based particles can have excellent electrical properties and the resulting MLCC can have excellent mechanical integrity, as described further below.

It should be understood that the heat-treated, coated particles may be processed using other conventional techniques and that devices other than MLCCs may be formed using such particles.

As noted above, the methods of the invention may lead to a number of advantages that can improve the performance of dielectric layers and devices formed from the barium titanate-based particles described herein.

It is believed that an increase in the bond strength between coatings and barium-titanate based particles can result from partial or substantial diffusion of one or more components from the coating into the particles and in particular can be promoted by the partial diffusion of dopant species from coatings into particles. The resulting increase in bond strength reduces the possibility of coatings becoming detached from particles during subsequent processing steps (e.g., milling or mixing). The reduction in coating detachment can increase the uniformity of dopant distribution in dielectric layers formed from the particulate composition which can improve device performance. In particular, barium titanate particles having a primary particle size of less than about 1 micron, less than about 0.5 micron, less than about 0.25 micron or less than about 0.1 micron can benefit from promoting the diffusion of coating components into the primary barium titanate particle.

The heat treatment step may be one way of increasing the bond strength between coatings and barium titanate-based particles. It is believed that the heat treatment step may increase bond strength by promoting diffusion of components from a coating into the barium titanate particle.

The heating step may also remove water, or other volatile species, that may be present in the coating. As noted above, the water may be chemically associated with the dopant coating, for example, when the dopant compound is a metal hydroxide or metal hydrous oxide. The water also may be physically trapped within structure of the coating, particularly if the coating has a porous structure. Removal of water during the heating step eliminates the problem of water vaporization during the sintering step which can cause the dielectric layer to delaminate from the electrode and/or may deform the dielectric layer. Delamination and deformation of the dielectric layer can sacrifice the mechanical integrity of the resulting electronic device.

The heating step may also decompose other contaminants formed during the coating process which may otherwise sacrifice performance. For example, in some cases barium carbonate particles or needles (BaCO₃) may be produced during the coating processes. Heat treatment can decompose such particles or needles prior to formation of green layers and sintering.

The heating step may also reduce the average specific surface area of the coated particles. It is believed that the specific surface area of the coated particles is reduced as a result of the reduction in porosity of the coating. The porosity is reduced because the coating densifies and shrinks in thickness during heating. In some cases, the average specific surface area of the particles are reduced by at least about 25%; in other cases, by at least about 50%. The reduction may be determined by measuring the average specific surface area of a representative number of particles before and after heat treatment using known techniques such as BET (m²/g) measurements. Unless otherwise noted, BET surface area measurements are made using ASTM Method D6556-01, titled “Carbon Black—Total and External Surface Area by Nitrogen Adsorption.”

The reduction in specific surface area may increase the dispersibility of the particles in liquids during subsequent processing steps. Increasing particle dispersibility can increase the density of green tapes formed from the particles. For example, it has been observed that heat treatment followed by milling can lead to green tape densities that are up to about 10% greater than green tapes made from coated particles that are not heat treated. Electrical properties of dielectric layers made from green tapes typically improve as green tape density increases.

It should be understood that not all of the above-identified advantages may be achieved in all methods of the present invention.

The present invention will be further illustrated by the following examples, which are intended to be illustrative in nature and are not to be considered as limiting the scope of the invention.

### EXAMPLE 1

This example illustrates some of the effects of heat treating coated barium titanate-based particles at different temperatures. Barium titanate particles were hydrothermally produced, calcined at about 1000° C., and were sequentially coated by precipitating a series of dopants onto the barium titanate particles. This technique is detailed in co-pending U.S. Patent Application Serial number not yet assigned, filed on even date herewith and titled “PROCESS FOR COATING CERAMIC PARTICLES AND COMPOSITIONS FORMED FROM THE SAME,” by Venigalla et al (Attorney Docket No. 01056), which is incorporated by reference in its entirety herein. (Particles used in other examples provided herein were produced similarly unless otherwise noted.) The particles were divided into seven lots and were heat treated for two hours at various temperatures as shown below in Table 1. BET surface area, volatility, carbon content, A/B ratio and Horiba PSD were measured and recorded for each of the lots of powder.

TABLE 1

| | | | | | | | 98E Horiba PSD | | |
|---|---|---|---|---|---|---|---|---|---|
| Sample | Heat (2 hrs) | BET | % LOD | % LOI | | | (μm) | | |
| I.D. | Treatment | (m²/g) | @200 C. | @1000 C. | C (ppm) | A/B | d10 | d50 | d99.9 |
| Control | None | 7.00 | 0.50 | 1.50 | 2264 | 1.020 | 0.54 | 0.83 | 2.47 |
| A | 500° C. | 5.60 | 0.50 | 0.81 | 1773 | 1.021 | 0.56 | 0.86 | 2.70 |
| B | 600° C. | 5.44 | 0.50 | 0.68 | 1549 | 1.021 | 0.58 | 0.88 | 2.80 |
| C | 700° C. | 4.62 | 0.00 | 0.45 | 1187 | 1.020 | 0.69 | 1.00 | 45.0 |
| D | 800° C. | 3.68 | 0.00 | 0.38 | 760 | 1.021 | 0.67 | 1.30 | 46.0 |
| E | 900° C. | 3.42 | 0.00 | 0.08 | 304 | 1.022 | 0.75 | 1.6 | 36.0 |
| F | 1000° C. | 3.15 | 0.00 | 0.05 | 194 | 1.022 | 0.85 | 2.0 | 34.0 |

The results shown in Table 1 show a significant decrease in BET surface area as the heat treatment temperature was increased. For instance, in the range of 800-900° C. the BET surface area is about half that of particles that did not receive heat treatment (control). This lower surface area measurement indicates increased crystallization/condensation of the dopant layer(s). The BET surface area of 3.15 m²/g for the sample treated at 1000° C. approaches a BET surface area of 3.13 m²/g that was measured for undoped particles.

The results also show a decrease in volatility that is reflected in the loss on drying (% LOD) and loss on ignition (% LOI) readings. The % LOD readings indicate a loss of moisture from both hydration of dopant compounds as well as from adsorbed moisture. Additional weight losses above 600° C., as indicated by a decrease in % LOI at 1000° C., are attributed to the loss of non-water compounds such as, the decomposition of barium carbonate (BaCO₃) into barium oxide (BaO). The decrease in carbon content is similar to the decrease in % LOI and can also be attributed to the decomposition of barium carbonate (BaCO₃) to barium oxide (BaO).

There was no significant change in the A/B ratio at any temperature.

Particle size distribution (PSD) readings indicated that heat treatment at 600° C. or less did not affect the particle size and as a result did not affect the state of dispersion of the particles. At higher temperatures, (700° C. or greater) the maximum particle size (d99.9) showed increased coarsening which indicated some aggregation of particles. It is believed that this was due to the fusion of dopant layers, primarily driven by silica.

This example shows that decreased surface area, decreased volatility, decreased carbon content, constant A/B ratio, and increased particle size resulting from heat treating the doped particles.

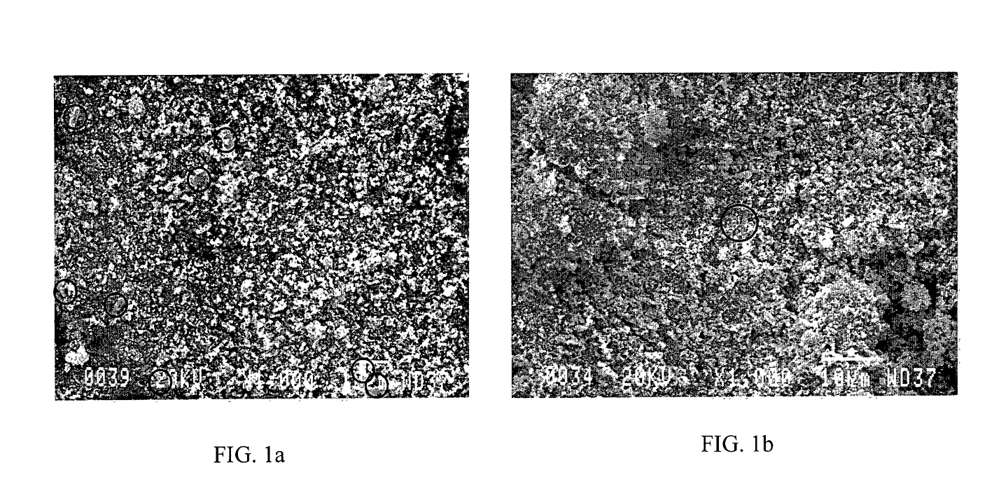

FIG. 1 and Table 2 provide a comparison of coated barium titanate particles (produced as in Example 1) before and after heat treatment. FIG. 1b is the same material as that in FIG. 1a except that it has been heat treated for 2 hours at 750° C. and ball milled for 6 hours. Black circles have been added to each of the micrographs to indicate the position of barium carbonate needles. The heat treatment process reduced the number of needles per scan from 8 (FIG. 1A) to 1 (FIG. 1B). This reduction in barium carbonate improves the uniformity of the microstructure and increases purity. Particle size was also reduced after heat treatment followed by ball milling.

TABLE 2

| | | BET | C | LOD | LOI | HORIBA PSD (microns) | | | | |
|---|---|---|---|---|---|---|---|---|---|---|
| Lot# | Treatment | m²/g | ppm | Wt % | Wt % | D10 | D50 | D90 | D99.9 | C.V. |
| G | As Coated | 6.26 | 1847 | 0.50 | 1.23 | 0.56 | 0.88 | 1.49 | 3.06 | 41.1 |
| G* | 750 C., 2 h | 3.48 | 1032 | 0.06 | 0.45 | 0.49 | 0.74 | 1.18 | 2.38 | 37.3 |

*Dry milled in a ball mill for 6 h after heat treatment

### EXAMPLE 2

Tables 3 and 4 provide data for additional coated particles with barium titanate particle lots H and I being evaluated. Results are provided for lot H as i) coated, ii) after heat treatment for 4 hours at 750° C., iii) after heat treatment followed by ball milling for 6 hours, and iv) after heat treatment for 4 hours at 1000° C. Results for lot I are provided for samples i) after coating, ii) after heat treatment for 4 hours at 750° C. and iii) after heat treatment for 4 hours at 750° C. followed by 6 hours of ball milling. The particle size distribution results indicate some agglomeration after heat treatment, but also show particles being successfully deagglomerated by ball milling, resulting in particles of a smaller size than the coated, non-heat treated particles.

TABLE 3

| | | BET | C | LOD | LOI | HORIBA PSD (microns) | | | | |
|---|---|---|---|---|---|---|---|---|---|---|
| Lot # | Treatment | m²/g | ppm | Wt % | Wt % | D10 | D50 | D90 | D99.9 | C.V. |
| H | As Coated | 7.65 | 1849 | 0.70 | 1.52 | 0.592 | 1.099 | 2.049 | 4.190 | 49.44 |
| H | Heat treated | 3.73 | 726 | 0.00 | 0.32 | 0.615 | 1.161 | 2.182 | 4.619 | 50.45 |
| | @ 750 C. 4 h, | | | | | | | | | |
| | milled | | | | | | | | | |
| H* | Milled | — | — | — | — | 0.531 | 0.925 | 1.666 | 3.467 | 46.47 |
| H | 1000 C., 4 h | 2.49 | 122 | 0.00 | 0.03 | 0.677 | 1.309 | 2.494 | 5.424 | 52.16 |

*Dry milled in a ball mill for 6 h after heat treatment

TABLE 4

| | | BET | C | LOD | LOI | HORIBA PSD (microns) | | | | |
|---|---|---|---|---|---|---|---|---|---|---|
| Lot # | Treatment | m²/g | ppm | Wt % | Wt % | D10 | D50 | D90 | D99.9 | C.V. |
| I | As Coated | 7.00 | 2264 | 0.60 | 1.50 | 0.48 | 0.76 | 1.27 | 2.46 | 39.90 |
| I | 750 C., 4 h | 3.77 | 952 | 0.00 | 0.34 | 0.53 | 0.88 | 1.65 | 4.65 | 53.11 |
| I* | Heat treated @ | — | — | — | — | 0.46 | 0.72 | 1.17 | 2.36 | 39.00 |
| | 750° C. 4 h, | | | | | | | | | |
| | and Milled | | | | | | | | | |

### EXAMPLE 3

Table 5 provides data showing the green density of green tapes formed from lot H after i) coating, ii) coating and heat treating at 750° C., iii) coating, heat treating at 750° C., and ball milling for 6 hours, and iv) coating and heat treating at 1000° C. The highest grain densities were achieved with those coated particles that were both heat treated and ball milled to deagglomerate the heat treated particles. While only heat treating does not show a significant increase in green density, heat treating followed by milling results in a significantly higher density than the non-heat treated powder. For example, the average density of heat treated and milled powder (3.61 g/cc) is significantly improved over that of coated, non-heat treated powder (3.40 g/cc).

TABLE 5

| | | | Weight | Green |
|---|---|---|---|---|
| Lot # | Description | Thickness (μm) | (g) | Density (g/cc) |
| H | As-Coated | 5.28 | 0.0650 | 3.42 |
| | | 5.28 | 0.0652 | 3.43 |
| | | 5.36 | 0.0646 | 3.35 |
| Average | | 5.31 | 0.0649 | 3.40 |
| H | Heat treated | 5.38 | 0.0658 | 3.40 |
| | @750 C. | | | |
| | | 5.40 | 0.0653 | 3.36 |
| | | 5.39 | 0.0658 | 3.39 |
| Average | | 5.39 | 0.0656 | 3.38 |
| H | Heat treated @ | 4.95 | 0.0644 | 3.61 |
| | 750° C. and milled | | | |
| | | 4.96 | 0.0645 | 3.61 |
| | | 4.96 | 0.0644 | 3.60 |
| Average | | 4.96 | 0.0644 | 3.61 |
| H | Heat treated | 5.00 | 0.0611 | 3.39 |
| | @10000 C. | | | |
| | | 4.96 | 0.0609 | 3.41 |
| | | 4.98 | 0.0609 | 3.40 |
| Average | | 4.98 | 0.0610 | 3.40 |

### EXAMPLE 4

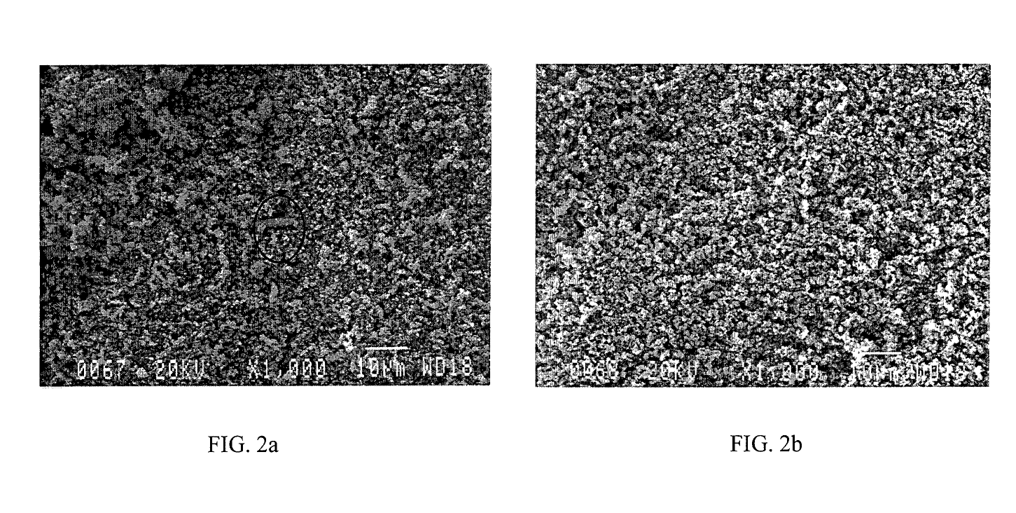

The photomicrographs of FIG. 2 show a difference in the presence of barium carbonate needles for a sample of barium titanate particles treated at 800° C. (FIG. 2A) and at 1000° C. (FIG. 2B). While one needle is shown (circled) in FIG. 2A, there are no needles visible in FIG. 2B, the powder that was treated at 1000° C. This shows a greater reduction in barium carbonate at higher temperatures.

### EXAMPLE 5

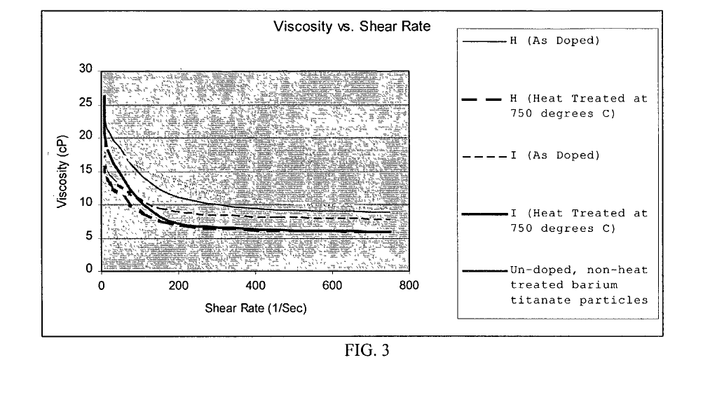

FIG. 3 provides the viscosity vs. shear rate behavior for two heat treated coated samples in comparison with two non-heat treated samples. The graph shows a lower viscosity for both heat treated powders over a broad range of sheer rates. The highest viscosity was noted for the undoped, non-heat treated barium titanate particles. This shows that heat treatment after doping lowers viscosity and provides for better dispersion behavior for the production of MLCCs.

### EXAMPLE 6

Table 6 provides green sheet densities for a 4 to 5 micron thick tape made using a water-based binding system for i) doped, ii) doped and heat treated, and iii) doped, heat treated, and deagglomerated samples. The method of deagglomeration is also provided, where appropriate. The highest average densities are obtained with those powders that were both heat treated and deagglomerated (et pulverized). The highest densities were achieved with the powder that was heat treated at 1000° C. and then jet pulverized. This shows that a higher density tape can be made with a powder that is heat treated and deagglomerated.

TABLE 6

| | | | Weight | Green |
|---|---|---|---|---|
| Powder | Description | Thickness (μm) | (g) | Density (g/cc) |
| H | coated | 4.825 | 0.0630 | 3.627 |
| | Treated @ 750 C. | 4.825 | 0.0634 | 3.650 |
| | Jet Pulverized | 4.825 | 0.0632 | 3.638 |
| Average | | 4.825 | 0.0632 | 3.638 |
| H | coated | 4.850 | 0.0640 | 3.666 |
| | Treated @ 1000 C. | 4.875 | 0.0640 | 3.647 |
| | Jet Pulverized | 4.825 | 0.0642 | 3.696 |
| Average | | 4.850 | 0.0641 | 3.671 |
| H | coated | 4.675 | 0.0600 | 3.565 |
| | As Doped, No Heat | 4.700 | 0.0600 | 3.546 |
| | Jet Pulverized | 4.725 | 0.0600 | 3.527 |
| Average | | 4.700 | 0.0600 | 3.546 |
| H | As Doped | 5.175 | 0.0632 | 3.392 |
| | No Heat Treatment | 5.125 | 0.0630 | 3.415 |
| | No Jet Pulverizing | 5.150 | 0.0628 | 3.387 |
| Average | | 5.150 | 0.0630 | 3.398 |
| I | coated | 4.480 | 0.0558 | 3.460 |
| | Treated @ 750 C. | 4.465 | 0.0558 | 3.471 |
| | No | 4.480 | 0.0564 | 3.497 |
| | Deagglomeration | | | |
| Average | | 4.475 | 0.0560 | 3.476 |
| I | coated | 4.633 | 0.0600 | 3.597 |
| | Treated @ 750 C. | 4.660 | 0.0598 | 3.565 |
| | Roller Milled | 4.657 | 0.0596 | 3.555 |
| Average | | 4.650 | 0.0598 | 3.572 |

### EXAMPLE 7

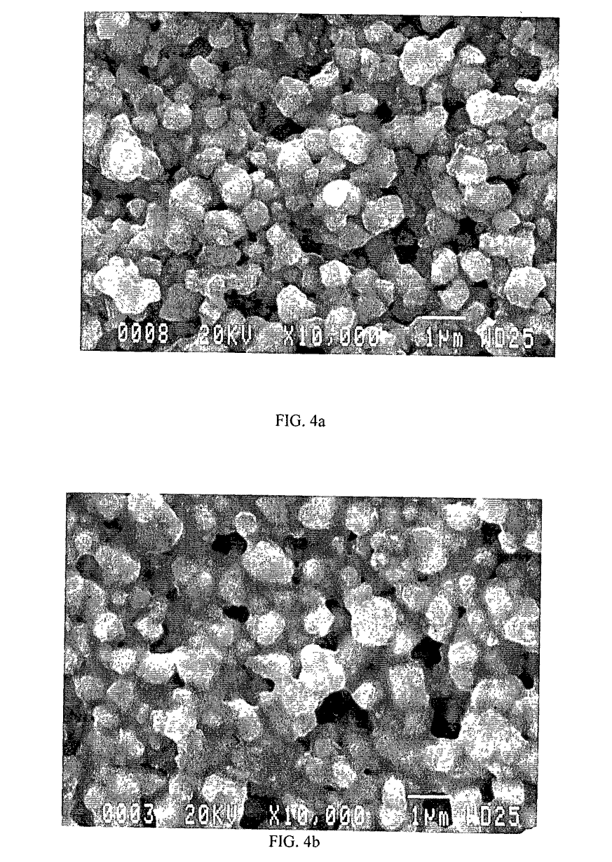

FIGS. 4a and 4b provide two SEM micrographs illustrating the packed green sheet density of two samples, one of which was produced from coated and non-heat treated powder (FIG. 4a) and one which was produced from powder that was coated, heat treated at 750° C. and milled (FIG. 4b). The micrographs are of powder H and show improved dispersion of the binder phase (noncrystalline film around the ceramic particles) in the heat treated sample of FIG. 4b when compared to the non-heat treated sample of FIG. 4a. It is also apparent from the micrographs that the surface roughness of the particles is decreased by the heat treatment process. FIG. 4b also shows improved porosity with more tightly packed particles.

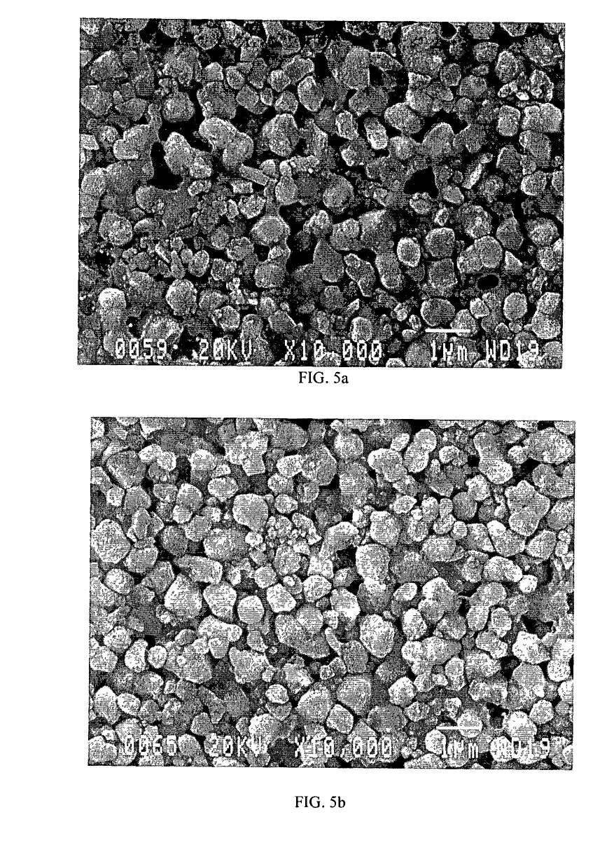

FIGS 5a and 5b provide two micrographs showing the bottom side, i.e., the side in contact with the substrate during casting, of the green sheets shown in FIGS. 4a and 4b. FIG. 5a shows the doped non-heat treated sample and FIG. 5b shows the doped heat treated sample. The heat treated material of FIG. 5b is more tightly packed than that of FIG. 5a and the segregation of the binder phase is less pronounced in the heat treated sample of FIG. 5b than it is in the non-heat treated sample of FIG. 5a. This shows that improved particle packing and improved dispersion of the binder phase obtained with particles that have been heat treated and milled.

It should be understood that although particular embodiments and examples of the invention have been described in detail for purposes of illustration, various changes and modifications may be made without departing from the scope and spirit of the invention. Accordingly, the invention is not to be limited except as by the appended claims.

What is claimed is:

1. A method of processing barium titanate-based particles comprising:
hydrothermally producing barium titanate-based particles;
forming a coating on surfaces of the barium titanate-based particles to produce coated barium titanate-based particles; and
heating the coated barium titanate-based particles to a temperature of greater than about 400° C. and less than about 1150° C. to produce heat-treated, coated barium titanate-based particles.

2. The method of claim 1, wherein the coating comprises at least one dopant metal compound.

3. The method of claim 2, wherein the dopant metal compound comprises a metal oxide, metal hydroxide, or metal hydrous oxide.

4. The method of claim 2, wherein the coating comprises more than one dopant metal compound.

5. The method of claim 4, wherein the coating includes a plurality of layers, each layer comprising a different dopant metal compound.

6. The method of claim 5 comprising promoting at least partial diffusion of a component of the coating into the barium titanate-based particles.

7. The method of claim 4, wherein the dopant metal compounds are distributed throughout the coating.

8. The method of claim 1, wherein the coated particles have an average specific surface area and heating the coated barium titanate-based particles decreases the average specific surface area of the coated particles.

9. The method of claim 8, wherein the average specific surface area of the coated particles decreases by at least 25%.

10. The method of claim 8, wherein the average specific surface area of the coated particles decreases by at least 50%.

11. The method of claim 1, wherein the coating comprises water and heating the coated barium titanate-based particles removes at least a portion of the water in the coating.

12. The method of claim 11, wherein heating the coated barium titanate-based particles removes substantially all of the water in the coating.

13. The method of claim 1, wherein the coating is porous.

14. The method of claim 1, further comprising milling the heat-treated, coated barium titanate-based particles.

15. The method of claim 1, further comprising dispersing the heat-treated, coated barium titanate-based particles in a liquid to form a dispersion.

16. The method of claim 15, further comprising forming a green layer from the dispersion of heat-treated, coated barium titanate-based particles.

17. The method of claim 16, further comprising sintering the green layer.

18. The method of claim 1, further comprising processing the heat-treated, coated barium titanate-based particles to form a dielectric layer in an MLCC.

19. The method of claim 1, comprising heating the coated barium titanate-based particles to a temperature of greater than about 500° C. and less than about 1000° C. to produce heat-treated, coated barium titanate-based particles.

20. The method of claim 1, comprising heating the coated barium titanate-based particles to a temperature of greater than about 800° C. and less than about 1000° C. to produce heat-treated, coated barium titanate-based particles.

21. The method of claim 1, wherein the coating is formed on surfaces of the barium titanate-based particles by precipitating at least one dopant metal compound.

22. The method of claim 1, wherein the barium titanate-based particles have an A/B ratio and further comprising adjusting the A/B ratio of the barium titanate-based particles prior to the heating the coated barium titanate-based particles.

23. The method of claim 22, further comprising adjusting the A/B ratio of the barium titanate-based particles by coating the barium titanate-based particles with a compound comprising an A group element.

24. The method of claim 22, further comprising adjusting the A/B ratio between a value of about 1.005 and about 1.035.

25. The method of claim 1, further comprising heating the barium titanate-based particles to a temperature of greater than about 500° C. and less than about 1150° C. prior to forming a coating on surfaces of the barium titanate-based particles.

26. The method of claim 1, comprising hydrothermally producing barium titanate-based particles having an average primary particle size of less than 0.25 micron.

27. The method of claim 1 comprising promoting at least partial diffusion of a component of the coating into the barium titanate-based particles.

28. A method of processing barium titanate-based particles comprising:
hydrothermally producing barium titanate-based particles;
forming a coating on surfaces of the barium titanate-based particles to produce coated barium titanate-based particles;
heating the coated barium titanate-based particles to a temperature of greater than about 400° C. to produce heat-treated, coated barium titanate-based particles;
forming a green layer comprising the heat-treated, coated barium titanate-based particles; and
sintering the green layer.

29. The method of claim 28, wherein the coating comprises at least one dopant metal compound.

30. The method of claim 29, wherein the coating comprises more than one dopant metal compound.

31. The method of claim 28, comprising heating the coated barium titanate-based particles to a temperature of greater than about 500° C. and less than about 1150° C. to produce a heat-treated, coated barium titanate-based particles.

32. The method of claim 28, further comprising adjusting the A/B ratio of the barium titanate-based particles by coating the particles with a compound comprising an A group element.

33. The method of claim 28, wherein the coating comprises water and heating the coated barium titanate-based particles removes at least a portion of the water in the coating.

34. The method of claim 28, further comprising heating the barium titanate-based particles to a temperature of greater than about 500° C. and less than about 1150° C. prior to forming a coating on surfaces of the barium titanate-based particles.

35. The method of claim 28, wherein the coated particles have an average specific surface area and heating the coated barium titanate-based particles decreases the average specific surface area of the coated particles.

36. The method of claim 35, wherein the average specific surface area of the coated particles decreases by at least 25%.

37. The method of claim 35, wherein the average specific surface area of the coated particles decreases by at least 50%.

38. The method of claim 28 comprising promoting at least partial diffusion of a component of the coating into the barium titanate-based particles.

39. A method of processing barium titanate-based particles comprising:
forming a coating on surfaces of barium titanate-based particles to produce coated barium titanate-based particles having an average specific surface area; and
reducing the average specific surface area of the coated barium titanate-based particles by heating the coated barium titanate-based particles.

40. The method of claim 39, wherein the average specific surface area of the coated particles decreases by at least 25%.

41. The method of claim 39, wherein the average specific surface area of the coated particles decreases by at least 50%.

42. The method of claim 39, further comprising hydrothermally producing the barium titanate-based particles.

43. The method of claim 39, comprising heating the coated barium titanate-based particles to a temperature of greater than about 500° C. and less than about 1150° C. to produce heat-treated, coated barium titanate-based particles.

44. The method of claim 39, further comprising adjusting the A/B ratio of the barium titanate-based particles by coating the particles with a compound comprising an A group element.

45. The method of claim 39, wherein the coating comprises water and heating the coated barium titanate-based particles removes at least a portion of the water in the coating.

46. The method of claim 39, wherein the coating comprises more than one dopant metal compound.

47. The method of claim 39, further comprising heating the barium titanate-based particles to a temperature of greater than about 500° C. and less than about 1150° C. prior to forming a coating on surfaces of the barium titanate-based particles.

48. The method of claim 39 wherein the heating promotes at least partial diffusion of a coating component into the particles.

49. The method of claim 40 wherein the heating promotes at least partial diffusion of a coating component into the particles.

50. A method of processing barium titanate-based particles comprising:
forming a dopant coating on surfaces of barium titanate-based particles to produce coated barium titanate-based particles; and
promoting at least partial diffusion of the dopant into the barium titanate-based particles.

51. A coated barium titanate particle comprising:
a primary particle comprising barium titanate and having an average primary particle size of less than about 0.5 micron; and
a dopant coating disposed on the primary particle wherein the coated barium titanate particle exhibits a BET surface area of less than about 5.6 m²/g.

52. The coated barium titanate particle of claim 51 exhibiting a BET surface area of less than about 4.62 m²/g.

53. The coated barium titanate particle of claim 52 exhibiting a BET surface area of less than about 3.42 m²/g.

54. Coated barium titanate particles comprising:
primary particles comprising barium titanate; and
a dopant coating disposed on the primary particles wherein the dopant is at least partially diffused into the primary particles.

55. The coated barium titanate particles of claim 54 further comprising a second dopant coating disposed on a portion of the dopant coating.

56. The coated barium titanate particles of claim 54 wherein the primary particles have an average primary particle size of less than about 0.5 micron.

57. The coated barium titanate particles of claim 56 wherein the primary particles have an average primary particle size of less than about 0.25 micron.
